(19) United States
(12) Patent Application Publication
(10) Pub. No.: US 2025/0323537 A1
(43) Pub. Date: Oct. 16, 2025

(54) Detecting Coil Misalignment in Wireless Charging Systems

(71) Applicant: Apple Inc., Cupertino, CA (US)

(72) Inventors: Zaid A. AbuKhalaf, Sunnyvale, CA (US); Daniel Ye, San Francisco, CA (US); Ali Abdolkhani, Auckland (NZ); Wynand Malan, Auckland (NZ)

(21) Appl. No.: 18/781,299

(22) Filed: Jul. 23, 2024

Related U.S. Application Data
(60) Provisional application No. 63/632,781, filed on Apr. 11, 2024.

(51) Int. Cl. H02J 50/90; H02J 7/00; H02J 50/00; H02J 50/10; H02J 50/40

(52) U.S. Cl. CPC H02J 50/90; H02J 7/0013; H02J 7/0044; H02J 50/005; H02J 50/10; H02J 50/402; H02J 2207/20

(57) ABSTRACT

A wireless charging system may include a wireless power receiving device that receives wireless power signals from a wireless power transmitting device. The wireless power transmitting device may include positioning equipment that moves a wireless power transfer coil to align the wireless power transfer coil for wireless power transfer. The wireless power transmitting device may periodically assess coil alignment during a wireless power transfer session by intermittently checking efficiency or an inductive coupling factor.

This application claims the benefit of U.S. provisional patent application No. 63/632,781, filed Apr. 11, 2024, which is hereby incorporated by reference herein in its entirety.

### FIELD

This relates generally to power systems and, more particularly, to wireless power systems for charging electronic devices.

### BACKGROUND

In a wireless charging system, a wireless power transmitting device with a wireless power transfer coil transmits wireless power to a wireless power receiving device with a wireless power transfer coil. The wireless power receiving device charges a battery and/or powers components using the wireless power. If the wireless power transfer coils are misaligned, the efficiency of the wireless power transfer may be lower than desired.

### SUMMARY

An electronic device may be configured to transfer wireless power with an additional electronic device. The electronic device may include a wireless power transfer coil, an inverter configured to supply alternating-current drive signals to the wireless power transfer coil, positioning equipment configured to move the wireless power transfer coil, and control circuitry configured to, after a wireless power transfer session commences, cause a first pause in the wireless power transfer session for a first duration of time, determine an inductive coupling factor between the electronic device and the additional electronic device during the first pause, cause a second pause in the wireless power transfer session for a second duration of time that is greater than the first duration of time based on the inductive coupling factor, and move the wireless power transfer coil using the positioning equipment during the second pause.

An electronic device may be configured to transfer wireless power with an additional electronic device. The electronic device may include a wireless power transfer coil, an inverter configured to supply alternating-current drive signals to the wireless power transfer coil, positioning equipment configured to move the wireless power transfer coil, and control circuitry configured to: identify that the additional electronic device has lowered a rectifier output load to a non-zero magnitude during a wireless power transfer session, determine an inductive coupling factor between the electronic device and the additional electronic device while the rectifier output load in the additional electronic device has the non-zero magnitude, and move the wireless power transfer coil using the positioning equipment based on the inductive coupling factor.

An electronic device may be configured to transfer wireless power with an additional electronic device. The electronic device may include a wireless power transfer coil, an inverter configured to supply alternating-current drive signals to the wireless power transfer coil, positioning equipment configured to move the wireless power transfer coil, and control circuitry configured to gather baseline efficiency information while transferring the wireless power with the additional electronic device during a calibration phase of a wireless power transfer session, receive efficiency information from the additional electronic device while transferring the wireless power with the additional electronic device during the wireless power transfer session, and move the wireless power transfer coil using the positioning equipment based on the baseline efficiency information and the efficiency information from the additional electronic device.

### BRIEF DESCRIPTION OF THE DRAWINGS

FIG. 1 is a schematic diagram of an illustrative wireless power system in accordance with some embodiments.

FIG. 2 is a circuit diagram of wireless power transmitting and receiving circuitry in accordance with some embodiments.

FIG. 3 is a side view of an illustrative wireless power transmitting device such as a wireless charging puck connected to a connector plug via a cable in accordance with some embodiments.

FIG. 4 is a diagram of an illustrative wireless power system showing different power levels at different locations within the system in accordance with some embodiments.

FIG. 5A is a side view of an illustrative wireless power system with positioning equipment before a coil alignment procedure in accordance with some embodiments.

FIG. 5B is a side view of the illustrative wireless power system of FIG. 5A after the coil alignment procedure in accordance with some embodiments.

FIG. 6 is a top view of an illustrative wireless power transmitting device with a coil that may be repositioned beneath a charging surface in accordance with some embodiments.

FIG. 7 is a timeline of illustrative operations of a wireless power transmitting device that checks wireless power transfer efficiency to assess coil alignment in accordance with some embodiments.

FIG. 8 is a flowchart of an illustrative method of operating a wireless power transmitting device that checks wireless power transfer efficiency to assess coil alignment in accordance with some embodiments.

FIG. 9 is a timeline of illustrative operations of a wireless power transmitting device that estimates an inductive coupling factor to assess coil alignment in accordance with some embodiments.

FIG. 10 is a flowchart of an illustrative method of operating a wireless power transmitting device that estimates an inductive coupling factor to assess coil alignment in accordance with some embodiments.

### DETAILED DESCRIPTION

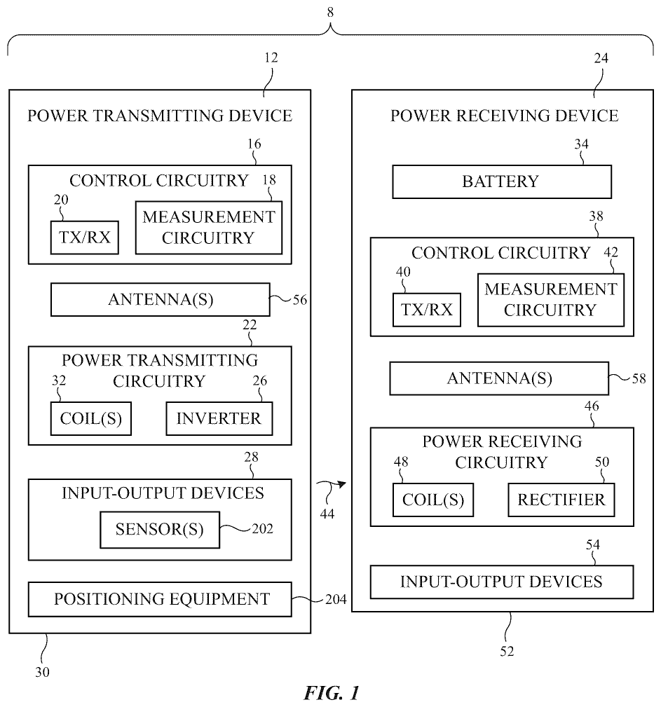

An illustrative wireless power system (also sometimes called a wireless charging system) is shown in FIG. 1. As shown in FIG. 1, wireless power system 8 may include one or more wireless power transmitting devices such as wireless power transmitting device 12 and one or more wireless power receiving devices such as wireless power receiving device 24. Wireless power system 8 may sometimes also be referred to herein as wireless power transfer (WPT) system 8 or wireless power system 8. Wireless power transmitting device 12 may sometimes also be referred to herein as power transmitter (PTX) device 12 or simply as PTX 12. Wireless power receiving device 24 may sometimes also be referred to herein as power receiver (PRX) device 24 or simply as PRX 24.

PTX device 12 includes control circuitry 16. Control circuitry 16 is mounted within housing 30. PRX device 24 includes control circuitry 38 mounted within a corresponding housing 52 for PRX device 24. Exemplary control circuitry 16 and control circuitry 38 are used in controlling the operation of WPT system 8. This control circuitry may include processing circuitry that includes one or more processors such as microprocessors, power management units, baseband processors, digital signal processors, microcontrollers, graphics processing units (GPUs), central processing units (CPUs), application processors (APs), application-specific integrated circuits with processing circuits, and/or other processing circuits. The processing circuitry implements desired control and communications features in PTX device 12 and PRX device 24. For example, the processing circuitry may be used in controlling power to one or more coils, determining and/or setting power transmission levels, generating and/or processing sensor data (e.g., to detect foreign objects and/or external electromagnetic signals or fields), processing user input, handling negotiations between PTX device 12 and PRX device 24, sending and receiving in-band and out-of-band data, making measurements, and/or otherwise controlling the operation of WPT system 8.

Control circuitry in WPT system 8 (e.g., control circuitry 16 and/or 38) is configured to perform operations in WPT system 8 using hardware (e.g., dedicated hardware or circuitry), firmware and/or software. Software code for performing operations in WPT system 8 is stored on non-transitory computer readable storage media (e.g., tangible computer readable storage media) in the control circuitry of WPT system 8. The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16 and/or 38.

PTX device 12 may be a stand-alone power adapter (e.g., a wireless charging mat or charging puck that includes power adapter circuitry), may be a wireless charging mat or puck that is connected to a power adapter or other equipment by a cable, may be an electronic device (e.g., a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment), may be equipment that has been incorporated into furniture, a vehicle, or other system, may be a removable battery case, or may be other wireless power transfer equipment.

PRX device 24 may be an electronic device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a wireless tracking tag, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment.

PTX device 12 may be connected to a wall outlet (e.g., an alternating current power source), may be coupled to a wall outlet via an external power adapter, may have a battery for supplying power, and/or may have another source of power. In implementations where PTX device 12 is coupled to a wall outlet via an external power adapter, the adapter may have an alternating-current (AC) to direct-current (DC) power converter that converts AC power from a wall outlet or other power source into DC power. If desired, PTX device 12 may include a DC-DC power converter for converting the DC power between different DC voltages. Additionally or alternatively, PTX device 12 may include an AC-DC power converter that generates the DC power from the AC power provided by the wall outlet (e.g., in implementations where PTX device 12 is connected to the wall outlet without an external power adapter). DC power may be used to power control circuitry 16. During operation, a controller in control circuitry 16 uses power transmitting circuitry 22 to transmit wireless power to power receiving circuitry 46 of PRX device 24.

Power transmitting circuitry 22 may have switching circuitry, such as inverter circuitry 26 formed from transistors, that are turned on and off based on control signals provided by control circuitry 16 to create AC current signals through one or more wireless power transmitting coils such as wireless power transmitting coil(s) 32. These coil drive signals cause coil(s) 32 to transmit wireless power. In implementations where coil(s) 32 include multiple coils, the coils may be disposed on a ferromagnetic structure, arranged in a planar coil array, or may be arranged to form a cluster of coils (e.g., two or more coils, 5-10 coils, at least 10 coils, 10-30 coils, fewer than 35 coils, fewer than 25 coils, or other suitable number of coils). In some implementations, PTX device 12 includes only a single coil 32.

As the AC currents pass through one or more coils 32, alternating-current electromagnetic (e.g., magnetic) fields (wireless power signals 44) are produced that are received by one or more corresponding receiver coils such as coil(s) 48 in PRX device 24. In other words, one or more of coils 32 is inductively coupled to one or more of coils 48. PRX device 24 may have a single coil 48, at least two coils 48, at least three coils 48, at least four coils 48, or another suitable number of coils 48. When the alternating-current electromagnetic fields are received by coil(s) 48, corresponding alternating-current currents are induced in coil(s) 48. The AC signals that are used in transmitting wireless power may have any desired frequency (e.g., 100-400 kHz, 1-100 MHz, between 1.7 MHz and 1.8 MHz, less than 2 MHz, between 100 kHz and 2 MHz, etc.). Rectifier circuitry such as rectifier circuitry 50, which contains rectifying components such as synchronous rectification transistors arranged in a bridge network, converts received AC signals (received alternating-current signals associated with wireless power signals 44) from one or more coils 48 into DC voltage signals for powering PRX device 24. Wireless power signals 44 are sometimes referred to herein as wireless power 44 or wireless charging signals 44. Coils 32 are sometimes referred to herein as wireless power transfer coils 32, wireless charging coils 32, or wireless power transmitting coils 32. Coils 48 are sometimes referred to herein as wireless power transfer coils 48, wireless charging coils 48, or wireless power receiving coils 48.

The DC voltage produced by rectifier circuitry 50 (sometime referred to as rectifier output voltage V_{RECT_DC}) may be used in charging a battery such as battery 34 and may be used in powering other components in PRX device 24 such as control circuitry 38, input-output (I/O) devices 54, etc. PTX device 12 may also include input-output devices such as input-output devices 28. Input-output devices 54 and/or input-output devices 28 may include input devices for gathering user input and/or making environmental measurements and may include output devices for providing a user with output.

As examples, input-output devices 28 and/or input-output devices 54 may include a display (screen) for creating visual output, a speaker for presenting output as audio signals, light-emitting diode status indicator lights and other light-emitting components for emitting light that provides a user with status information and/or other information, haptic devices for generating vibrations and other haptic output, and/or other output devices. Input-output devices 28 and/or input-output devices 54 may also include sensors for gathering input from a user and/or for making measurements of the surroundings of WPT system 8.

Input-output devices 28 may include one or more sensors 202 that detect the location of one or more coils 48 in PRX 24 when PRX 24 is placed on PTX 12 for wireless power transfer. The one or more sensors 202 may include one or more sensor coils, one or more magnetic sensors, one or more temperature sensors, etc.

It may be desirable for coil 32 to be aligned with coil 48 to improve efficiency during wireless power transfer. PTX 12 may include positioning equipment 204 that is configured to move coil 32 based on the location of coil 48 detected by sensor(s) 202. In this way, coil 32 may be aligned with coil 48 regardless of where on PTX 12 the PRX 24 is placed. During a wireless power transfer session, PRX 24 or PTX 12 may move relative to the other device such that coil 48 becomes misaligned with coil 32. When misalignment between coils 32 and 48 is detected, sensor(s) 202 may detect the new location of coil 48 and positioning equipment 204 may move coil 32 to become aligned with the new location of coil 48.

Positioning equipment 204 may include one or more stepper motors, piezoelectric actuators, motors, linear electromagnetic actuators, shape memory alloys (SMAs), and/or other electronic components for adjusting the position of coil(s) 32.

The example in FIG. 1 of PRX device 24 including battery 34 is illustrative. More generally, an electronic device may include a power storage device 34. Power storage device 34 may be a battery, or may be, for example, a supercapacitor that stores charge.

PTX device 12 and PRX device 24 may communicate wirelessly using in-band or out-of-band communications. Implementations using in-band communication may utilize, for example, frequency-shift keying (FSK) and/or amplitude-shift keying (ASK) techniques to communicate in-band data between PTX device 12 and PRX device 24. Wireless power and in-band data transmissions may be conveyed using coils 32 and 48 concurrently. When PTX 12 sends in-band data to PRX 24, wireless transceiver (TX/RX) circuitry 20 may modulate wireless charging signal 44 to impart FSK or ASK communications, and wireless transceiver circuitry 40 may demodulate the wireless charging signal 44 to obtain the data that is being communicated. When PRX 24 sends in-band data to PTX 12, wireless transceiver (TX/RX) circuitry 40 may modulate wireless charging signal 44 to impart FSK or ASK communications, and wireless transceiver circuitry 20 may demodulate the wireless charging signal 44 to obtain the data that is being communicated.

Implementations using out-of-band communication may utilize, for example, hardware antenna structures and communication protocols such as Bluetooth or NFC to communicate out-of-band data between PTX device 12 and PRX device 24. Power may be conveyed wirelessly between coils 32 and 48 concurrently with the out-of-band data transmissions. Wireless transceiver circuitry 20 may wirelessly transmit and/or receive out-of-band signals to and/or from PRX device 24 using an antenna such as antenna 56. Wireless transceiver circuitry 40 may wirelessly transmit and/or receive out-of-band signals to and/or from PTX device 12 using an antenna such as antenna 58.

Control circuitry 16 in PTX device 12 has measurement circuitry 18 that may be used to perform measurements of one or more characteristics external to PTX device 12. For example, measurement circuitry 18 may detect external objects on or adjacent the charging surface of the housing of PTX device 12. While shown in FIG. 1 as being separate from power transmitting circuitry 22 for the sake of clarity, measurement circuitry 18 may form a part of power transmitting circuitry 22 if desired.

Measurement circuitry 18 may detect foreign objects such as coils, paper clips, and other metallic objects, may detect the presence of PRX device 24 (e.g., circuitry 18 may detect the presence of one or more coils 48 and/or magnetic core material associated with coils 48), and/or may detect the presence of other power transmitting devices in the vicinity of PTX device 12 and/or WPT system 8. Measurement circuitry 18 may also be used to make sensor measurements using a capacitive sensor, may be used to make temperature measurements, and/or may otherwise be used in gathering information indicative of whether a foreign object, power transmitting device, power receiving device, or other external object (e.g., PRX device 24) is present on or adjacent to the coil(s) 32 of PTX device 12. If desired, PRX device 24 may include measurement circuitry 42. Measurement circuitry 42 may perform one or more of the measurements performed by measurement circuitry 18 (e.g., for or using coil(s) 48 on PRX device 24).

Each one of housing 30 and housing 52 may be formed from plastic, metal, fiber-composite materials such as carbon-fiber materials, wood and other natural materials, glass, other materials, and/or combinations of two or more of these materials.

The example in FIG. 1 of PTX 12 transmitting wireless power and PRX 24 receiving wireless power is merely illustrative. PTX 12 may optionally be capable of receiving wireless power signals using coil(s) 32 and PRX 24 may optionally be capable of transmitting wireless power signals using coil(s) 48. When a device is capable of both transmitting and receiving wireless power signals, the device may include both an inverter and a rectifier.

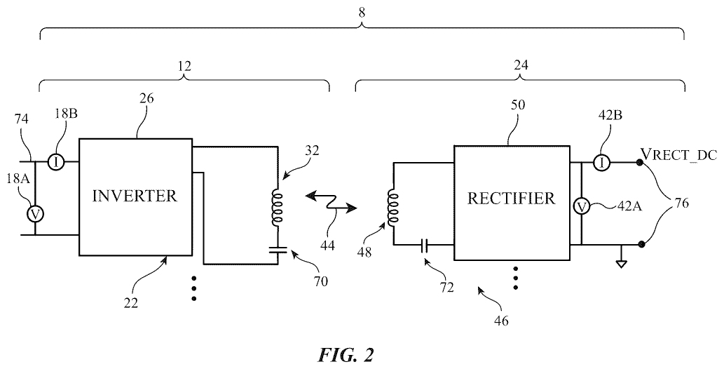

FIG. 2 is a circuit diagram of illustrative wireless charging circuitry for system 8. As shown in FIG. 2, circuitry 22 may include inverter circuitry such as one or more inverters 26 or other drive circuitry that produces wireless power signals that are transmitted through an output circuit that includes one or more coils 32 and capacitors such as capacitor 70. In some embodiments, device 12 may include multiple individually controlled inverters 26, each of which supplies drive signals to a respective coil 32. In other embodiments, an inverter 26 is shared between multiple coils 32 using switching circuitry.

During operation, control signals for inverter(s) 26 are provided by control circuitry 16 at one or more control inputs 74. A single inverter 26 and single coil 32 is shown in the example of FIG. 2, but multiple inverters 26 and multiple coils 32 may be used, if desired. In a multiple coil configuration, switching circuitry (e.g., multiplexer circuitry) may be used to couple a single inverter 26 to multiple coils 32 and/or each coil 32 may be coupled to a respective inverter 26. During wireless power transmission operations, transistors in one or more selected inverters 26 are driven by AC control signals from control circuitry 16. The relative phase between the inverters may be adjusted dynamically (e.g., a pair of inverters 26 may produce output signals in phase or out of phase).

The application of drive signals using inverter(s) 26 (e.g., transistors or other switches in circuitry 22) causes the output circuits formed from selected coils 32 and capacitors 70 to produce alternating-current electromagnetic fields (signals 44) that are received by wireless power receiving circuitry 46 using a wireless power receiving circuit formed from one or more coils 48 and one or more capacitors 72 in device 24.

Rectifier circuitry 50 is coupled to one or more coils 48 and converts received power from AC to DC and supplies a corresponding direct current output voltage V_{RECT_DC} across rectifier output terminals 76 for powering load circuitry in device 24 (e.g., for charging battery 34, for powering a display and/or other input-output devices 54, and/or for powering other components).

FIG. 2 shows how measurement circuitry 18 within PTX 12 may include one or more voltage sensors such as voltage sensor 18A and one or more current sensors such as current sensor 18B. Additionally, measurement circuitry 42 within PRX 24 may include one or more voltage sensors such as voltage sensor 42A and one or more current sensors such as current sensor 42B. The voltage and current sensors within system 8 may be used to determine power levels within the system.

The specific locations of sensors 18A, 18B, 42A, and 42B (on the DC sides of inverter 26 and rectifier 50 respectively) in FIG. 2 are merely illustrative. In general, voltage and current sensors may be positioned at any desired positions within the power transmitting circuitry 22 and the power receiving circuitry 46 (e.g., on the AC sides of inverter 26 and rectifier 50 if desired).

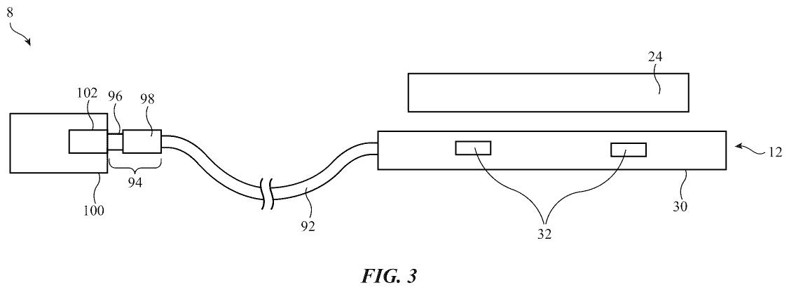

FIG. 3 is a cross-sectional side view of system 8 in an illustrative configuration in which wireless power transmitting device 12 is a wireless charging puck and in which wireless power receiving device 24 is a wristwatch, as an example. As shown in FIG. 3, device 12 has a device housing 30 (e.g., a disk-shaped puck housing formed form polymer, other dielectric material, and/or other materials). Device housing 30 may house a device microcontroller for communicating with plug 94, DC-DC power converter circuitry such as a step-down voltage converter (e.g., a buck converter), voltage regulator circuitry such as a low-dropout (LDO) regulator, wireless power transmitting circuitry such as inverter 26 (see FIG. 2), coil(s) 32, capacitor 70, near-field communications (NFC) circuitry for communicating with power receiving device 24, over-temperature protection (OTP) circuitry such as a temperature sensor, debug circuitry, filter circuitry, sensors 202 for locating a coil 48 in PRX 24, positioning equipment 204 for moving coil 32, magnetic alignment structures such as magnets for attracting device 24 during charging operations, and/or other power transmitting device components.

Cable 92 is coupled to device housing 30 and provides power to coil(s) 32. One end of cable 92 may be pigtailed to housing 30. The opposing end of cable 92 is terminated using plug 94. Plug 94 has a boot portion 98 sometimes referred to as the “boot” of the plug. Cable 92 and plug 94 may be considered part of PTX 12 or may be considered a separate component from PTX 12. Boot 98, which may sometimes be referred to as a connector boot, may be formed from polymer, metal, and/or other materials and may have an interior region configured to house electrical components (e.g., integrated circuits, discrete components such as transistors, printed circuits, etc.). Boot 98 has a first end connected to cable 92 and a second end connected to a connector portion 96 (sometimes referred to as the “connector” of the plug). Connector 96 may include pins configured to mate with corresponding pins in port 102 of external equipment such as device 100. Device 100 may be a stand-alone power adapter that converts alternating-current (AC) power to direct-current (DC) power, an electronic device such as a computer, or other equipment that provides DC power to plug 94 through port 102. Port 102 may be, for example, a USB port (e.g., a USB type-C port, a USB 4.0 port, a USB 3.0 port, a USB 2.0 port, a micro-USB port, etc.) or a Lightning connector port. Plug 96 having a connector protruding from boot 98 may be referred to as a male plug. Plug 96 may be a reversible plug (i.e., a plug that may be mated with a corresponding connector port in at least two different and symmetrical orientations).

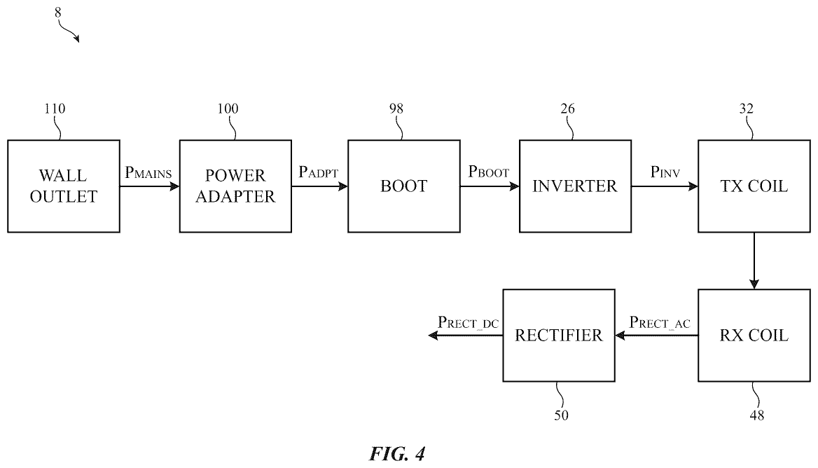

During wireless power transfer operations, it may be desirable to measure the efficiency of wireless power transfer between PTX 12 and PRX 24. FIG. 4 shows the transfer of power through system 8. A power adapter 100 (such as the power adapter of FIG. 3) may receive power from a power source such as wall outlet 110. Wall outlet 110 may provide AC power at a first level P_{MAINS}. Power adapter 100 may convert the received AC power to DC power. The DC power output from power adapter may have a second level P_{ADPT}. A plug including boot portion 98 may be coupled to power adapter 100. Boot portion 98 may include power conversion circuitry that outputs DC power with a third level P_{BOOT}. The power output from boot portion 98 may be provided to inverter 26 within housing 30 (e.g., using cable 92 and/or other circuitry within power transmitting device 12). Inverter 26 uses the input power P_{BOOT} to create AC current signals through wireless power transmitting coil 32. The AC signals generated by inverter 26 and provided to transmitting (TX) coil 32 may have a fourth power level P_{INV}.

As the AC currents pass through one or more coils 32, alternating-current electromagnetic (e.g., magnetic) fields (wireless power signals 44) are produced that are received by one or more corresponding receiver coils such as coil(s) 48 in PRX device 24. The signals received at RX coil 48 may have a fifth power level P_{RECT_AC}. Rectifier 50 converts the AC power received at RX coil 48 to DC power at a sixth level P_{RECT_DC}.

There may be power inefficiency associated with each stage of the transfer of power through system 8. In other words, power adapter 100 has an associated power conversion and/or consumption inefficiency that causes P_{ADPT} to be less than P_{MAINS}, boot portion 98 has an associated power inefficiency that causes P_{BOOT} to be less than P_{ADPT}, inverter 26 has an associated power inefficiency that causes P_{INV} to be less than P_{BOOT}, wireless power transfer between TX coil 32 and RX coil 48 has an associated power inefficiency that causes P_{RECT_AC} to be less than P_{INV}, and rectifier 50 has an associated power inefficiency that causes P_{RECT_DC} to be less than P_{RECT_AC} (e.g., P_{MAINS}>P_{ADPT}>P_{BOOT}>P_{INV}>P_{RECT_AC}>P_{RECT_DC}).

In view of the varying power levels within wireless power system 8, there are many ways to characterize efficiency within the wireless power system. In general, efficiency may refer to a ratio of two power levels within the system, with the numerator's power level further downstream in the power transfer (and therefore lower) than the denominator's power level.

Efficiency of the wireless power transfer between PTX 12 and PRX 24 may be characterized by a ratio of at least one power level within PRX 24 and at least one power level within PTX 12 or power adapter 100. For example, the efficiency of wireless power transfer between PTX 12 and PRX 24 may be characterized as the ratio of P_{RECT_DC} and P_{INV} (e.g., E_{TRANSFER}=P_{RECT_DC}/P_{INV}).

An operating efficiency of PTX 12 may be characterized by a ratio of two power levels within PTX 12 or power adapter 100. For example, the operating efficiency of PTX 12 may be characterized as the ratio of P_{INV} and P_{ADPT} (e.g., EPTX=P_{INV}/P_{ADPT}) or as the ratio of P_{INV} and P_{BOOT} (e.g., EPTX=P_{INV}/P_{BOOT}).

During wireless power transfer operations, PRX 24 may report efficiency information to PTX 12 and/or PTX 12 may report efficiency information to PRX 24. The efficiency information may include efficiency information associated with the wireless power transfer (e.g., E_{TRANSFER}=P_{RECT_DC}/P_{INV}). In some cases, the efficiency may be determined by PRX 24 and reported directly to PTX 12. In other cases, PRX 24 may transmit information (e.g., power level information, current information, and/or voltage information) to PTX 12 that PTX 12 subsequently uses to derive an efficiency.

As one example, PRX 24 may determine P_{RECT_DC} (e.g., using current and/or voltage measurements). PRX 24 may report P_{RECT_DC} to PTX 12 and PTX 12 subsequently determines efficiency E_{TRANSFER} using the received P_{RECT_DC} and an internally determined P_{INV}. Alternatively, PRX 24 may receive information on P_{INV} from PTX 12, determine E_{TRANSFER} using P_{INV} and P_{RECT_DC}, and report E_{TRANSFER} to PTX 12.

Power is a function of current and voltage. The power at a given point within system 8 may therefore be determined using current information and/or voltage information at the given point within system 8. To obtain current information and/or voltage information to calculate a power level, measurement circuitry within each electronic device may include current sensors and/or voltage sensors. FIG. 2 shows how PTX 12 may include voltage sensor 18A and/or current sensor 18B. Information from these sensors may be used to determine the power level P_{INV} of inverter 26. FIG. 2 shows how PRX 24 may include voltage sensor 42A and/or current sensor 42B. Information from these sensors may be used to determine the power level P_{RECT_DC} of rectifier 50.

In general, current and/or voltage sensors at any desired locations within system 8 (e.g., within power adapter 100, within boot 98, within inverter 26, and/or within rectifier 50) may be used to determine current information and/or voltage information at a desired location within system 8. The current information and/or voltage information may then be used to determine a power level associated with the desired location within the system.

When reporting efficiency information to PTX 12, PRX 24 may report proxy information for power levels within system 8. The proxy information may include current information and/or voltage information. As examples, PRX 24 may report efficiency information that includes a voltage V_{RECT_DC} associated with rectifier 50 (e.g., a voltage measured by voltage sensor 42A) and/or a current I_{RECT_DC} associated with rectifier 50 (e.g., a current measured by current sensor 42B). PTX 12 may use the proxy information V_{RECT_DC} and/or I_{RECT_DC} to determine P_{RECT_DC} and then determine the efficiency of the wireless power transfer using P_{RECT_DC}.

It should be noted that the magnitudes of efficiency levels, power levels, current levels, and/or voltage levels reported by PRX 24 may be averaged over a time period. The duration of the time period may be predetermined and/or may be adjusted in real time.

It is also noted that PTX 12 may report any desired efficiency information to PRX 24 if desired (e.g., such that PRX 24 may take suitable action based on real time efficiency).

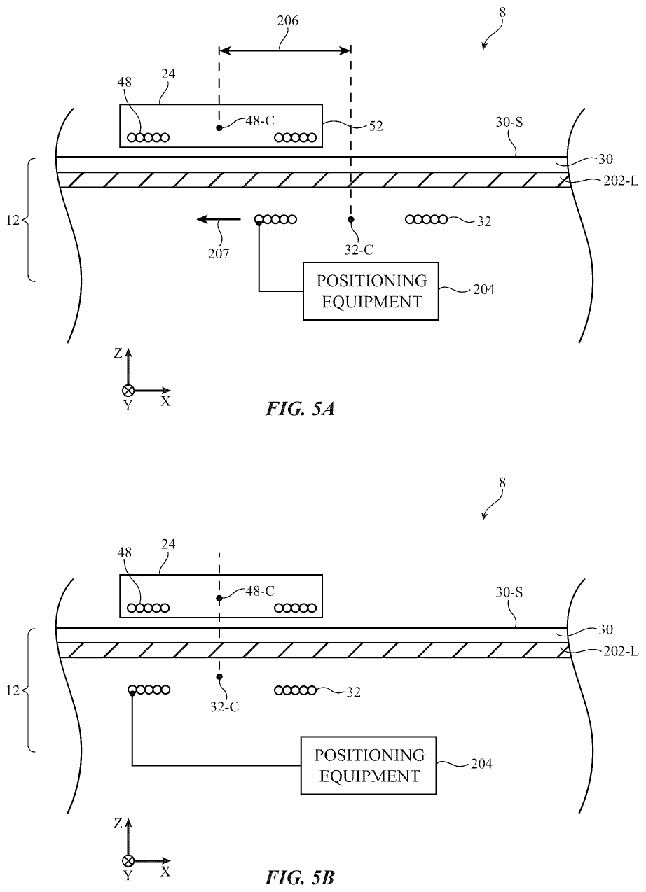

FIGS. 5A and 5B are cross-sectional side views of WPT system 8 before and after a coil alignment procedure. As shown in FIGS. 5A and 5B, PTX 12 has a housing with a charging surface 30-S. PRX 24 may be placed on surface 30-S to initiate a wireless power charging session. PRX 24 has a coil 48 within housing 52 whereas PTX 12 has a coil 32 within housing 30. In FIGS. 5A and 5B, the Z-axis is parallel to the surface normal of charging surface 30-S.

In FIG. 5A, when PRX 24 is initially placed on charging surface 30-S, coils 32 and 48 may be misaligned. As shown in FIG. 5A, coil 48 has a geometric center 48-C and coil 32 has a geometric center 32-C. Efficiency of wireless power transfer may be improved when centers 38-C and 32-C are aligned in the vertical direction (e.g., parallel to the Z-axis). However, the initial placement of PRX 24 in FIG. 5A results in a misalignment 206 between geometric centers 32-C and 48-C.

PTX 12 may include a sensor layer 202-L positioned below charging surface 30-S. Sensor layer 202-L may include one or more sensors 202 that detect the position of coil 48 within three-dimensional space. Sensor layer 202-L may determine the position of coil 48 within the XY-plane and optionally may determine the position of coil 48 in the Z-direction (e.g., a vertical offset of coil 48 relative to charging surface caused by housing 52, an intervening accessory such as a case, etc.).

PTX 12 may include positioning equipment 204 connected to coil 32. Positioning equipment 204 may be configured to move coil 32 within the XY-plane to align coil 32 with the position of coil 48 detected by sensor layer 202-L.

FIG. 5A shows how positioning equipment 204 may move coil 32 in direction 207 (e.g., the negative X-direction) to align coil 32 with the detected location of coil 48. After repositioning the coil, coil centers 32-C and 48-C may be aligned in the Z-direction as shown in FIG. 5B.

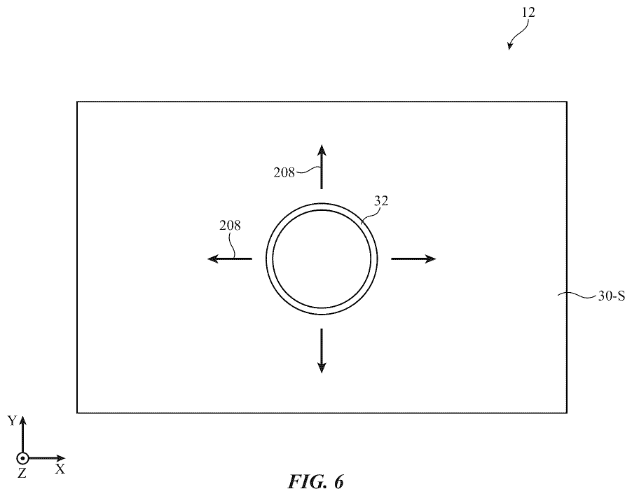

FIG. 6 is a top view of PTX 12 showing how coil 32 may be moved within the XY-plane. As shown in FIG. 6, coil 32 is positioned below charging surface 30-S. The footprint of charging surface 30-S may be greater than the footprint of coil 32 such that coil 32 may be moved within the XY-plane under the charging surface. Positioning equipment 204 may move coil 32 in any desired directions 208 within the XY-plane to align coil 32 with a coil in a PRX device.

The precision of sensor layer 202-L detecting the location of coil 48 may be improved when no wireless power transfer is ongoing between PTX 12 and PRX 24. Accordingly, when PRX 24 is placed on the charging surface of PTX 12, a coil alignment procedure may be performed before commencing a wireless power transfer session between PTX 12 and PRX 24. After the coil alignment procedure is completed, a wireless power transfer session may begin between PTX 12 and PRX 24.

In ideal conditions, coils 32 and 48 may remain aligned throughout a wireless power transfer session. However, in some situations PTX 12 and/or PRX 24 may shift during the wireless power transfer session, thus causing a misalignment between coils 32 and 48. The misalignment between coils 32 and 48 may undesirably reduce the efficiency of wireless power transfer. To improve the efficiency, it is therefore desirable to realign coils 32 and 48 when a misalignment occurs.

A first option to detect misalignment between coils 32 and 48 is to pause the wireless power transfer session for sufficiently long to locate coil 48 using sensor layer 202-L and determine if coil 32 is still aligned with coil 48. However, this procedure may require a longer pause in the wireless power transfer session than desired.

A second option to detect misalignment between coils 32 and 48 is to monitor the efficiency of the wireless power transfer during the wireless power transfer session. A calibration phase may be used to identify expected efficiencies under different operating conditions while the coils are aligned. Then, if the efficiency during the wireless power transfer session is lower than an expected efficiency for the current operating conditions, misalignment between the coils is detected and a coil realignment procedure may be performed.

A third option to detect misalignment between coils 32 and 48 is to estimate an inductive coupling factor (k) between PTX 12 and PRX 24 during the wireless power transfer session. If an inductive coupling factor estimated during the wireless power transfer session is lower than a baseline or predicted inductive coupling factor, misalignment between the coils is detected and a coil realignment procedure may be performed.

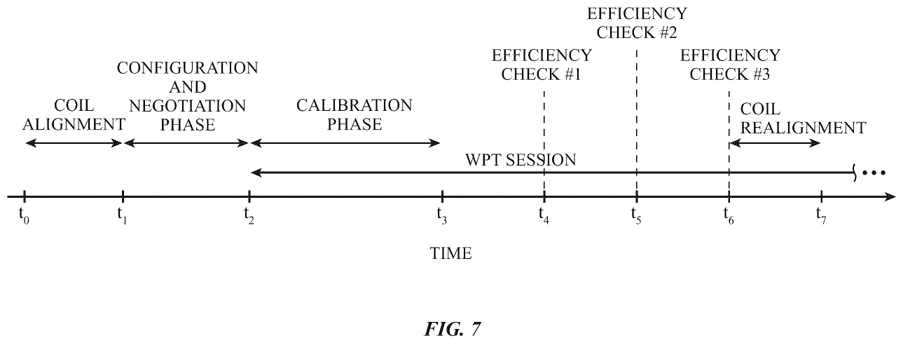

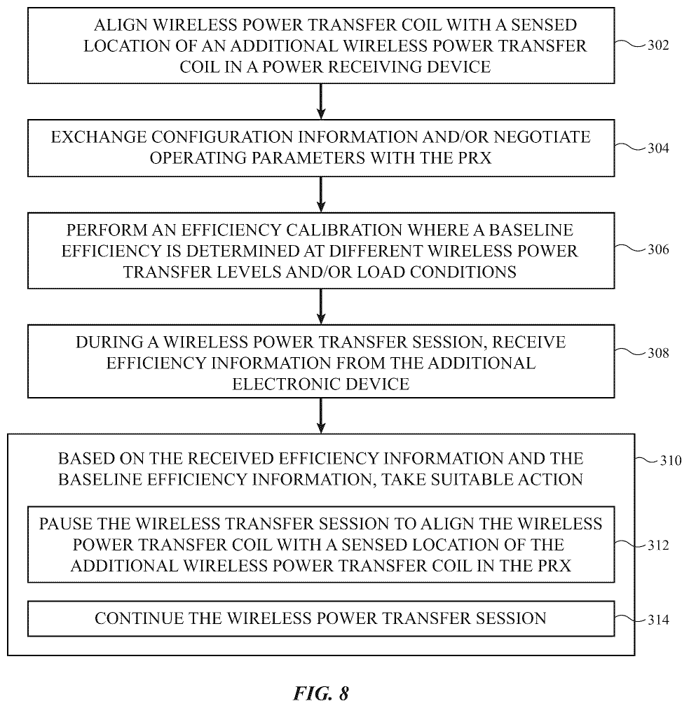

FIGS. 7 and 8 show additional details regarding the arrangement where the efficiency of the wireless power transfer is used to detect coil misalignment. FIG. 7 is a timeline showing various operations of PTX 12 over time and FIG. 8 is a flowchart of an illustrative method of operating PTX 12.

PRX 24 may be placed on charging surface 30-S of PTX 12 at to in FIG. 7. PTX 12 and/or PRX 24 may detect the placement of PRX 24 on charging surface 30-S and trigger a coil alignment procedure that is performed between t₀ and t₁. Between t₀ and t₁, sensors 202 in sensing layer 202-L may detect the location of coil 48 on charging surface 30-S. After detecting the location of coil 48 on charging surface 30-S, positioning equipment 204 may move coil 32 in PTX 12 to align the centers of coils 32 and 48 in a vertical direction (e.g., a direction orthogonal to the charging surface).

After the coils are aligned between t₀ and t₁, PTX 12 and PRX 24 may undergo a configuration and negotiation phase between t₁ and t₂. During the configuration and negotiation phase, PTX 12 and PRX 24 may exchange information using in-band communications and/or out-of-band communications. During configuration, PTX 12 may transmit identification information identifying PTX 12, information regarding the capabilities of PTX 12 (e.g., available power transfer frequencies, power transfer levels, operating modes, etc.), etc. Similarly, PRX 24 may transmit identification information identifying PRX 24, information regarding the capabilities of PRX 24 (e.g., available power transfer frequencies, power transfer levels, operating modes, etc.), status information (e.g., real time state of charge information), etc.

During configuration, PTX 12 may perform a digital ping in which inverter 26 is turned on to transmit low-level wireless power signals to PRX 24 using coil 32. The digital ping may provide sufficient power to wake up PRX 24 in the event that PRX 24 has no battery power with which to operate. PRX 24 may use the wireless power received from the digital ping to send a response packet to PTX 12 and proceed with the configuration and negotiation operations. If the digital ping performed by PTX 12 does not produce a response from a compatible PRX 24, PTX 12 may forego further wireless power transfer and will not commence a wireless power transfer session. During the digital ping, rectifier 50 may not have an output load. The digital ping operation may therefore sometimes be referred to as taking place while PRX 24 and/or rectifier 50 has a ‘no load’ condition.

During negotiation, PTX 12 and PRX 24 may negotiate a power transmission frequency for the wireless power signals transmitted by PTX 12 to PRX 24, a power level for the wireless power signals transmitted by PTX 12 to PRX 24, a power control profile for the wireless power transfer session, and/or other wireless power transfer and/or communication parameters.

After the configuration and negotiation phase is complete at t₂, the PTX and PRX may begin a wireless power transfer session. The wireless power transfer session may include sustained transmission of wireless power at a negotiated power level and/or frequency (or a default power level and/or frequency).

When the wireless power transfer session (WPT session) begins, there may be a calibration phase between t₂ and t₃ to obtain baseline efficiency information associated with wireless power transfer between PTX 12 and PRX 24. The calibration phase may be performed at the beginning of the WPT session when the alignment between coils 32 and 48 (as set during the coil alignment procedure) is likely to remain undisturbed.

During the calibration phase, PTX 12 may transmit wireless power to PRX 24 under various operating conditions. For example, PTX 12 may transmit wireless power to PRX 24 at various power levels (e.g., 7 W, 9 W, 11 W, 13 W, 15 W, etc.). In addition, PRX 24 may switch between different load conditions for the output of rectifier 50. The temperature of PTX 12 and/or PRX 24 may be recorded for each set of operating conditions during the calibration phase. The state of charge of PRX 24 may be recorded for each set of operating conditions during the calibration phase. The power transfer between PTX 12 and PRX 24 may have a unique efficiency for each set of operating conditions used during the calibration phase. As an example, there may be a first efficiency E_{B1} at first operating conditions (e.g., 7 W power level, low load condition), a second efficiency E_{B2} at second operating conditions (e.g., 11 W power level, medium load condition), a third efficiency E_{B3} at third operating conditions (e.g., 15 W power level, high load condition), etc. In general, any desired number of operating conditions may be tested for efficiency during the calibration phase. PTX 12 and/or PRX 24 may trigger and/or negotiate the changes in operating conditions during the calibration phase.

It is noted that in FIG. 7 power transmission may be sustained throughout the calibration phase and therefore the calibration phase is considered a subset of the WPT session that is performed at the beginning of the WPT session. This example is merely illustrative and in another possible nomenclature the calibration phase may be considered separate from the WPT session and may be performed after the configuration and negotiation phase and before the beginning of the WPT session.

After the calibration phase concludes at t₃, the WPT session may continue using a particular set of operating conditions negotiated by PTX 12 and/or PRX 24. The efficiency may then be regularly checked throughout the WPT session. FIG. 7 shows how a first efficiency check is performed at t₄, a second efficiency check is performed at t₅, a third efficiency check is performed at t₆, etc.

For each efficiency check, the efficiency of wireless power transfer between PTX 12 and PRX 24 is determined by PTX 12. For example, PTX 12 may determine that there is a first efficiency E_{R1} (sometimes referred to as a real time efficiency) at t₄, a second efficiency E_{R2} at t₅, a third efficiency E_{R3} at t₆, etc. Each time the real time efficiency is checked, the real time efficiency may be compared to the baseline efficiency information obtained during the calibration phase. The comparison between the real time efficiency and the baseline efficiency information may indicate whether the coils have become misaligned.

Consider an example where, during the calibration phase (when the coils are assumed to be aligned), a power delivery of 15 W at a high load condition has an efficiency of 80% and a power delivery of 11 W at a medium load condition has an efficiency of 78%. Between t₃ and t₄, PTX 12 may deliver power at 15 W at a high load condition. The measured efficiency E_{R1} may be 80%. This real time efficiency matches the baseline efficiency from the same operating conditions during the calibration phase and PTX 12 may therefore determine that the coils are still aligned at t₄. Between t₄ and t₅, PTX 12 may deliver power at 11 W at a medium load condition. The measured efficiency E_{R2} may be 78%. This real time efficiency matches the baseline efficiency from the same operating conditions during the calibration phase and PTX 12 may therefore determine that the coils are still aligned at t₅. The baseline efficiency information from the calibration phase allows for PTX 12 to identify that the efficiency drop from 80% to 78% between t₄ and t₅ is likely caused by the change in the power level and/or load condition (and not coil misalignment). Between t₅ and t₆, PTX 12 may deliver power at 11 W at a medium load condition. The measured efficiency E_{R3} may be 76%. This real time efficiency is lower than the baseline efficiency from the same operating conditions during the calibration phase and PTX 12 may therefore determine that the coils are misaligned. The baseline efficiency information from the calibration phase allows for PTX 12 to identify that the efficiency drop from 78% to 76% between t₅ and the is likely caused by coil misalignment.

To summarize, the efficiency at different operating conditions during the calibration phase may allow for PTX 12 to estimate an expected efficiency for a given set of operating conditions for the real time efficiency checks during the WPT session. It is noted that the expected efficiency may be estimated using any desired number of real time operating conditions using any desired techniques. When the real time efficiency is lower than the expected efficiency by greater than a given amount (e.g., by greater than 0.1%, by greater than 0.5%, by greater than 1%, by greater than 2%, etc.), PTX 12 may determine that coils 32 and 48 are misaligned.

After PTX 12 determines that the coils are misaligned at t₆, PTX 12 may initiate a coil realignment procedure that is completed between t₆ and t₇. Between to and t₇, power transfer between PTX 12 and PRX 24 may be paused. While the power transfer is paused, sensors 202 in sensing layer 202-L may detect the new location of coil 48 on charging surface 30-S. After detecting the new location of coil 48 on charging surface 30-S, positioning equipment 204 may move coil 32 in PTX 12 to align the centers of coils 32 and 48 in a vertical direction.

After the coils are aligned between t₆ and t₇, the WPT session may resume and efficiency checks may again be performed intermittently to continually monitor coil alignment.

The pausing of power transfer during the coil realignment may sometimes be referred to as cloaking. After the cloaking period is complete (e.g., at t₇), the WPT session may resume using the operating parameters from the start of the cloaking period (e.g., the same operating parameters from before the cloaking period are used after the cloaking period). Cloaking may allow for the coil realignment to be performed at a high accuracy without necessitating repeating the configuration and negotiation phase and the calibration phase after the conclusion of the coil realignment. Alternatively, the configuration and negotiation phase and/or calibration phase may be performed after the coil realignment is completed if desired.

It is noted that the duration of the cloaking period to allow coil realignment may be negotiated by PTX 12 and/or PRX 24 during the configuration and negotiation phase. Similarly, a frequency for the repeated efficiency checks may be negotiated by PTX 12 and/or PRX 24 during the configuration and negotiation phase. As one example, the efficiency checks may be performed at a regular interval of once per minute, once per thirty seconds, once per two minutes, etc. Instead or in addition, the efficiency checks may be performed at irregular intervals. Efficiency check may be triggered by input to one or more input-output devices in PTX 12 and/or PRX 24. As an example, input-output devices 54 in PRX 24 may include an accelerometer that detects movement of PRX 24. When the accelerometer in PRX 24 detects movement of PRX 24, PRX 24 may trigger an efficiency check in PTX 12. Similarly, input-output devices 28 in PTX 12 may include an accelerometer that detects movement of PTX 12. When the accelerometer in PTX 12 detects movement of PTX 12, PTX 12 may trigger an efficiency check. In general, any desired input (particularly those associated with likely coil misalignment) may be used to trigger an efficiency check.

FIG. 8 is a flowchart of an illustrative method of operating PTX 12. The operations of FIG. 8 may be performed by control circuitry 16 in PTX 12. During the operations of block 302, control circuitry 16 may align wireless power transfer coil 32 with a sensed location of wireless power transfer coil 48 in PRX 24. Aligning coil 32 with coil 48 may include sensing the location of coil 48 using sensors 202 (e.g., in sensor layer 202-L in FIGS. 5A and 5B) and then moving coil 32 to be aligned with the sensed location using positioning equipment 204.

Next, during the operations of block 304, PTX 12 may exchange configuration information and/or negotiate operating parameters with PRX 24. Exchanging configuration information may include exchanging device identification information, power transfer capability information, status information, etc. Negotiating operating parameters may include negotiating a power transmission frequency, a power transfer level, a cloaking duration, a frequency for efficiency checks during a wireless power transfer session, etc.

During the operations of block 306, PTX 12 may perform an efficiency calibration where a baseline efficiency is determined for different operating conditions. In particular, the baseline efficiency may be determined for different wireless power transfer levels, load conditions, temperatures, PRX state of charges (SOCs), etc. The operations of block 306 may be performed at the beginning of a wireless power transfer session (e.g., as soon as the WPT session commences) to maximize the likelihood of coils 32 and 48 being aligned during the calibration phase.

During the operations of block 308, PTX 12 may receive efficiency information from PRX 24. As previously discussed, the received efficiency information may be an efficiency measurement or information that may be used to calculate efficiency.

During the operations of block 310, PTX 12 may take suitable action based on the received efficiency information (from block 308) and the baseline efficiency information (from block 306). The operations of block 310 may include determining an expected efficiency based on the real time operating conditions (e.g., real time temperature, power transfer level, PRX load condition, PRX SOC, etc.) and comparing the real time efficiency (which is obtained from the received efficiency information from block 308) to the expected efficiency.

When the real time efficiency is lower than the expected efficiency by greater than a threshold amount, PTX 12 may pause the wireless transfer session to realign the coils as shown by the operations of block 312. When realigning coils 32 and 48 during the operations of block 312, PTX 12 may sense the location of coil 48 using sensors 202 (e.g., in sensor layer 202-L in FIGS. 5A and 5B) and then move coil 32 to be aligned with the sensed location using positioning equipment 204. The duration of the pause for coil realignment in block 312 may be greater than 100 milliseconds, greater than 1 second, greater than 10 seconds, greater than 20 seconds, greater than 30 seconds, etc.

When the real time efficiency differs from the expected efficiency by less than a threshold amount, PTX 12 may continue the wireless power transfer session as shown by the operations of block 314. The threshold amount may be greater than 0.1%, greater than 0.5%, greater than 1%, greater than 2%, etc. The PTX may repeat the operations of blocks 308 and 310 at a regular frequency to continually assess coil alignment throughout the wireless power transfer session. PTX 12 may optionally intermittently repeat the operations of blocks 308 and 310 at irregular intervals based on input to one or more input-devices in PTX 12 and/or PRX 24.

Other suitable actions that may be performed at block 310 may include providing an audio or visual notification (e.g., via display in PTX 12 and/or PRX 24 or a speaker in PTX 12 and/or PRX 24), stopping the wireless power transfer session, etc.

The order of the operations of FIG. 8 is merely illustrative and in general the operations of blocks 302-310 may be performed in any desired order.

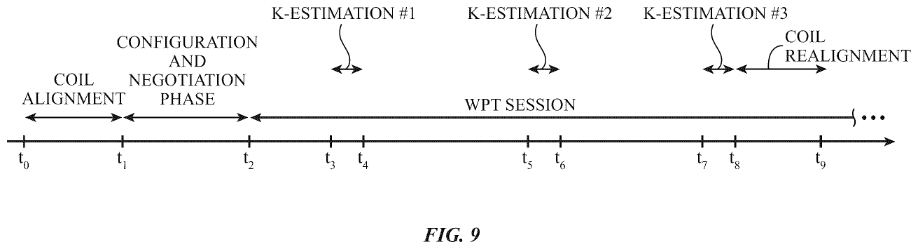

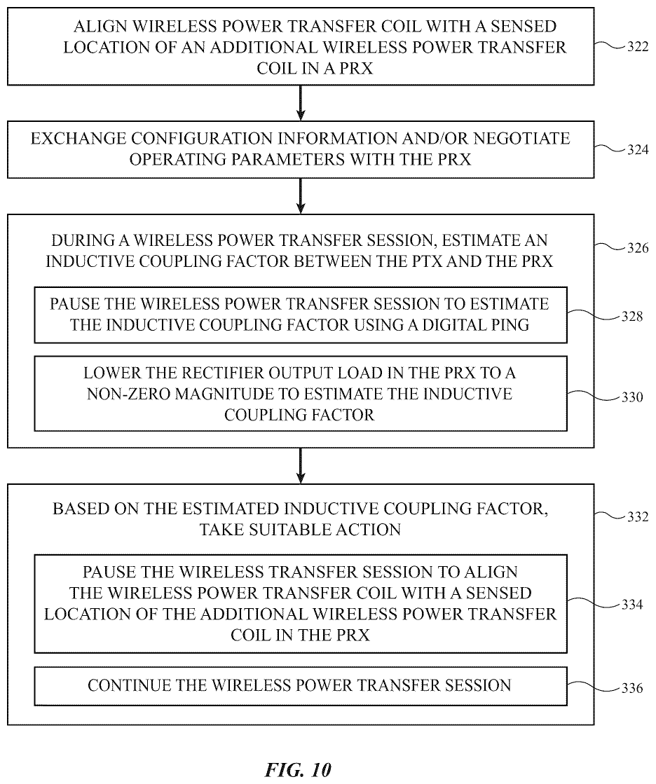

FIGS. 9 and 10 show additional details on the arrangement where an estimate of the inductive coupling factor is used to detect coil misalignment. FIG. 9 is a timeline showing various operations of PTX 12 over time and FIG. 10 is a flowchart of an illustrative method of operating PTX 12.

PRX 24 may be placed on charging surface 30-S of PTX 12 at to in FIG. 9. PTX 12 may perform a coil alignment procedure between t₀ and t₁ (as previously discussed in connection with FIG. 7). After the coils are aligned between to and t₁, PTX 12 and PRX 24 may undergo a configuration and negotiation phase between t₁ and t₂ (as previously discussed in connection with FIG. 7).

Additionally, during the configuration and negotiation phase, PTX 12 may estimate the magnitude of the inductive coupling factor (k) between PTX 12 and PRX 24. The inductive coupling factor k is equal to

$$\frac{M ′}{\sqrt{L {′}_{TX} L {′}_{RX}}} ,$$

where M′ is the mutual inductance, L′_{TX} is the inductance of coil 32, and L′_{RX} is the inductance of coil 48. To estimate k during the configuration and negotiation phase, PRX 24 may measure the rectifier output voltage (V_{RECT_DC}) (e.g., using voltage sensor 42A in FIG. 2) during a digital ping (e.g., a low-level transfer of wireless power from PTX 12 to PRX 24 at the beginning of the configuration phase and upon detection of PRX 24 on PTX 12). The rectifier output voltage during the digital ping may sometimes be referred to as a digital ping voltage. The digital ping voltage may be measured by PRX 24 and reported to PTX 12 (e.g., using in-band communication or out-of-band communication). PRX 24 may also transmit one or more additional coefficients (e.g., scaling coefficients) or parameters to PTX 12 to assist PTX 12 in the estimation of the inductive coupling factor. PTX 12 may use the received information to estimate the magnitude of k (e.g., kest=E₀*p+E₁, where kest is the estimated magnitude of k,

$$p = \frac{{V}_{RECT \_ DC}}{VCTX\_PP + {V}_{IN}} ,$$

V_{RECT_DC} is the digital ping voltage, V_{IN} is the input voltage for inverter 26, VCTX_PP is the measured peak to peak voltage across tuning capacitor 70, and E₀ and E₁ are selected to fit the k-estimation formula over a preferential range from 0.72 to 0.88).

After the configuration and negotiation phase is complete at t₂, the PTX and PRX may begin a wireless power transfer session. The wireless power transfer session may include sustained transmission of wireless power at a negotiated power level and/or frequency (or a default power level and/or frequency).

After the wireless power transfer session (WPT session) commences, PTX 12 may repeatedly estimate the inductive coupling factor in order to assess the alignment between coils 32 and 48. FIG. 9 shows an example where the inductive coupling factor is estimated a first time between t₃ and t₄, a second time between t₅ and t₆, and a third time between t₇ and t₈. Each time the k-estimation is performed, the estimate for k may be compared to the baseline estimate for k obtained during the configuration phase. The comparison between the real time k-estimate and the baseline k-estimate may indicate whether the coils have become misaligned.

Consider an example where, during the configuration phase (when the coils are assumed to be aligned), PTX estimates a magnitude of 0.8 for k. At the first k-estimation, PTX may estimate a magnitude of 0.8 for k. This real time k-estimate matches the baseline k-estimate and PTX 12 may therefore determine that the coils are still aligned at t₄. At the second k-estimation, PTX may estimate a magnitude of 0.79 for k. This real time k-estimate may be within a threshold difference between the real time k-estimate and the baseline k-estimate and PTX 12 may therefore determine that the coils are still aligned at t₆. At the third k-estimation, PTX may estimate a magnitude of 0.77 for k. This real time k-estimate may be greater than a threshold difference between the real time k-estimate and the baseline k-estimate and PTX 12 may therefore determine that the coils are misaligned at t₈.

To summarize, monitoring the k-estimate over time may allow for detection of coil misalignment. When the real time k-estimate differs from the baseline k-estimate by more than a given amount (e.g., greater than 0.01, greater than 0.02, greater than 0.03, greater than 0.05, etc.), PTX 12 may determine that coils 32 and 48 have become misaligned. Alternatively, instead of comparing the real time k-estimate to a baseline k-estimate, the real time k-estimate may be compared to a threshold (e.g., 0.78). When the real time k-estimate is less than the threshold, PTX 12 may determine that coils 32 and 48 have become misaligned. The threshold may have any desired magnitude. If desired, the threshold may be determined based on the real time operating conditions (e.g., temperature, power transfer level, PRX load condition, PRX SOC, etc.).

After PTX 12 determines that the coils are misaligned at t₈, PTX 12 may initiate a coil realignment procedure that is completed between t₅ and to. Between t₅ and to, power transfer between PTX 12 and PRX 24 may be paused. While the power transfer is paused, sensors 202 in sensing layer 202-L may detect the new location of coil 48 on charging surface 30-S. After detecting the new location of coil 48 on charging surface 30-S, positioning equipment 204 may move coil 32 in PTX 12 to align the centers of coils 32 and 48 in a vertical direction (orthogonal to the charging surface).

After the coils are aligned between t₅ and to, the WPT session may resume and k-estimations may again be performed intermittently to continually monitor coil alignment.

There are multiple ways to estimate the inductive coupling factor during each k-estimation. One technique is to pause the wireless power transfer session and estimate k using a digital ping. In other words, the same procedure used to estimate k during the configuration and negotiation phase may be used for each k-estimation during the wireless power transfer session.

When a digital ping is used for k-estimation during the wireless power transfer session, the wireless power transfer session is paused so that the k-estimation may be obtained using a digital ping operation (as previously described). During the digital ping operation, rectifier 50 may not have an output load. The digital ping operation may therefore sometimes be referred to as taking place while PRX 24 and/or rectifier 50 has a ‘no load’ condition.

The pause for k-estimation using a digital ping may be triggered by PTX 12 and/or PRX 24. For example, PTX 12 may send a notification to PRX 24 that the wireless power transfer operation will be paused imminently for a k-estimation operation. Alternatively, PRX 24 may send a request to PTX 12 to pause the wireless power transfer operation for a k-estimation operation. The pause for k-estimation may be for a duration of time that is negotiated during the configuration and negotiation phase. The duration of time needed for k-estimation may be less than the duration of time needed for coil alignment. Accordingly, PTX 12 and PRX 24 may negotiation a first duration of time to be used for pauses for k-estimation and a second duration of time that is longer than the first duration of time to be used for pauses for coil alignment. The first duration of time may be less than 5 seconds, less than 3 seconds, less than 2 seconds, less than 1 second, etc. The second duration of time may be greater than greater than 100 milliseconds, greater than 1 second, 10 seconds, greater than 20 seconds, greater than 30 seconds, etc. The second duration of time may be greater than the first duration of time by at least 3 seconds, at least 5 seconds, at least 10 seconds, at least 20 seconds, etc. The second duration of time may be at least 3 times greater than the first duration of time, at least 5 times greater than the first duration of time, at least 10 times greater than the first duration of time, etc.

Estimating k using a digital ping operation requires pausing the wireless power transfer session. Although a low level of wireless power is briefly transferred during the digital ping operation, the digital ping operation may not be considered a part of the dedicated wireless power transfer session. To avoid pausing the wireless power transfer session for k-estimation, the k-estimation may instead be performed during the wireless power transfer session while PRX 24 operates in a low load condition. At the beginning of each k-estimation period (e.g., at t₃, t₅, and t₇ in FIG. 9), PRX 24 may set (e.g., lower) the rectifier output load to a non-zero magnitude. The same non-zero magnitude may optionally be used for each k-estimation for consistency. This operating mode for PRX 24 and rectifier 50 may be referred to as a ‘low load’ condition. PRX 24 may switch to the low load condition for each k-estimation period. Outside of the k-estimation periods, PRX 24 may operate in a medium load condition or a high load condition during the wireless power transfer session. In general, PRX 24 may be operable in a variety of load conditions. PRX 24 may select an appropriate load condition based on real time operating parameters of PTX 12 and/or PRX 24. However, PRX 24 may switch to the same load condition (e.g., the low load condition) for each k-estimation regardless of the real time operating parameters.

As an example, the real time operating parameters of PTX 12 and PRX 24 may be associated with a high load condition between t₂ and t₇ in FIG. 9. PRX 24 therefore operates with the high load condition during the wireless power transfer session when k-estimation is not being performed (e.g., between t₂ and t₃, between t₄ and t₅, and between t₆ and t₇). However, when k-estimation is performed (e.g., between t₃ and t₄ and between t₅ and t₆) the load condition associated with k-estimation takes priority and PRX 24 operates with the low load condition.

It is noted that the same formulas used to estimate k during the digital ping operation may also be used to estimate k during the low load condition (e.g., kest=E₀*p+E₁, where kest is the estimated magnitude of k,

$$p = \frac{{V}_{RECT \_ DC}}{VCTX\_PP + {V}_{IN}} ,$$

V_{RECT_DC} is the voltage reported by PRX 24 during the low load condition, V_{IN} is the input voltage for inverter 26, VCTX_PP is the measured peak to peak voltage across tuning capacitor 70, and E₀ and E₁ are selected to fit the k-estimation formula over a preferential range from 0.72 to 0.88).

The power level of wireless power transferred by PTX 12 may be reduced during the k-estimation if desired. As an example, the real time operating parameters of PTX 12 and PRX 24 may be associated with a power transfer level of 15 W between t₂ and t₇ in FIG. 9. PTX 12 therefore operates at 15 W during the wireless power transfer session when k-estimation is not being performed (e.g., between t₂ and t₃, between t₄ and t₅, and between t₆ and t₇). However, when k-estimation is performed (e.g., between t₃ and t₄ and between t₅ and t₆) the PTX 12 may lower the power level (e.g., to 5 W).

A frequency for the repeated k-estimations during the wireless power transfer session may be negotiated by PTX 12 and/or PRX 24 during the configuration and negotiation phase. As one example, the k-estimations may be performed at a regular interval of once per minute or more, once per thirty seconds or more, once per two minutes or more, etc. Instead or in addition, the k-estimations may be performed at irregular intervals. A k-estimation may be triggered by input to one or more input-output devices in PTX 12 and/or PRX 24. As an example, input-output devices 54 in PRX 24 may include an accelerometer that detects movement of PRX 24. When the accelerometer in PRX 24 detects movement of PRX 24, PRX 24 may trigger a k-estimation in PTX 12. Similarly, input-output devices 28 in PTX 12 may include an accelerometer that detects movement of PTX 12. When the accelerometer in PTX 12 detects movement of PTX 12, PTX 12 may trigger a k-estimation. In general, any desired input (particularly those associated with likely coil misalignment) may be used to trigger a k-estimation.

FIG. 10 is a flowchart of an illustrative method of operating PTX 12. The operations of FIG. 10 may be performed by control circuitry 16 in PTX 12. During the operations of block 322, control circuitry 16 may align wireless power transfer coil 32 with a sensed location of wireless power transfer coil 48 in PRX 24. Aligning coil 32 with coil 48 may include sensing the location of coil 48 using sensors 202 (e.g., in sensor layer 202-L in FIGS. 5A and 5B) and then moving coil 32 to be aligned with the sensed location using positioning equipment 204.

Next, during the operations of block 324, PTX 12 may exchange configuration information and/or negotiate operating parameters with PRX 24. Exchanging configuration information may include exchanging device identification information, power transfer capability information, status information, etc. During the configuration phase, PTX 12 may estimate a baseline inductive coupling factor between PTX 12 and PRX 24. Negotiating operating parameters may include negotiating a power transmission frequency, a power transfer level, a first cloaking duration for k-estimation, a second cloaking duration for coil realignment, a frequency for k-estimation during a wireless power transfer session, etc.

During the operations of block 326, PTX 12 may estimate the inductive coupling factor (k) between PTX 12 and PRX 24. Estimating the inductive coupling factor may include pausing the wireless power transfer session to estimate the inductive coupling factor using a digital ping operation as shown in the operations of block 328. The duration of the pause for k-estimation may be less than 5 seconds, less than 3 seconds, less than 1 second, etc. Estimating the inductive coupling factor may include lowering the rectifier output load in PRX 24 to a non-zero magnitude to estimate the inductive coupling factor as shown in the operations of block 330. The duration of the low load mode for k-estimation may be less than 5 seconds, less than 3 seconds, less than 1 second, etc.

During the operations of block 332, PTX 12 may take suitable action based on the estimated inductive coupling factor from block 326. The operations of block 332 may include comparing the estimated inductive coupling factor from block 326 to the baseline inductive coupling factor that is estimated during block 324. Instead or in addition, the operations of block 332 may include comparing the estimated inductive coupling factor from block 326 to a predicted inductive coupling factor that is predicted based on the baseline inductive coupling factor and one or more additional real time operating parameters of PTX 12 and/or PRX 24.

When the estimated inductive coupling factor from block 326 is lower than the baseline inductive coupling factor and/or the predicted inductive coupling factor, control circuitry 16 may determine that coils 32 and 48 are misaligned. When coils 32 and 48 are determined to be misaligned, PTX 12 may pause the wireless transfer session to realign the coils as shown by the operations of block 334. When realigning coils 32 and 48 during the operations of block 334, PTX 12 may sense the location of coil 48 using sensors 202 (e.g., in sensor layer 202-L in FIGS. 5A and 5B) and then move coil 32 to be aligned with the sensed location using positioning equipment 204. The duration of the pause for coil realignment in block 334 may be greater than 100 milliseconds, greater than 1 second, greater than 10 seconds, greater than 20 seconds, greater than 30 seconds, etc.

When the estimated inductive coupling factor from block 326 is greater than, equal to, or within a threshold difference of the baseline inductive coupling factor and/or the predicted inductive coupling factor, control circuitry 16 may determine that coils 32 and 48 are aligned. When coils 32 and 48 are determined to be sufficiently aligned, PTX 12 may continue the wireless power transfer session as shown by the operations of block 336.

Other suitable actions that may be performed at block 332 may include providing an audio or visual notification (e.g., via display in PTX 12 and/or PRX 24 or a speaker in PTX 12 and/or PRX 24), stopping the wireless power transfer session, etc.

PTX 12 may repeat the operations of blocks 326 and 332 at a regular frequency to continually assess coil alignment throughout the wireless power transfer session. PTX 12 may optionally intermittently repeat the operations of blocks 326 and 332 at irregular intervals based on input to one or more input-devices in PTX 12 and/or PRX 24.

The order of the operations of FIG. 10 is merely illustrative and in general the operations of blocks 322-336 may be performed in any desired order.

The foregoing is merely illustrative and various modifications can be made to the described embodiments. The foregoing embodiments may be implemented individually or in any combination.

What is claimed is:

1. An electronic device configured to transfer wireless power with an additional electronic device, the electronic device comprising:
a wireless power transfer coil;
an inverter configured to supply alternating-current drive signals to the wireless power transfer coil;
positioning equipment configured to move the wireless power transfer coil; and
control circuitry configured to:
after a wireless power transfer session commences, cause a first pause in the wireless power transfer session for a first duration of time;
during the first pause, determine an inductive coupling factor between the electronic device and the additional electronic device;
based on the inductive coupling factor, cause a second pause in the wireless power transfer session for a second duration of time that is greater than the first duration of time; and
during the second pause, move the wireless power transfer coil using the positioning equipment.

2. The electronic device of claim 1, wherein causing the second pause based on the inductive coupling factor comprises causing the second pause in accordance with determining that the inductive coupling factor is lower than a threshold inductive coupling factor.

3. The electronic device of claim 1, wherein the control circuitry is further configured to:
before the wireless power transfer session commences, determine a baseline inductive coupling factor between the electronic device and the additional electronic device, wherein causing the second pause based on the inductive coupling factor comprises causing the second pause in accordance with determining that the inductive coupling factor has dropped by greater than a threshold amount relative to the baseline inductive coupling factor.

4. The electronic device of claim 1, wherein the control circuitry is configured to, during the wireless power transfer session, repeatedly:
cause the first pause in the wireless power transfer session for the first duration of time; and
determine an inductive coupling factor between the electronic device and the additional electronic device during the first pause.

5. The electronic device of claim 1, wherein determining the inductive coupling factor comprises determining the inductive coupling factor using a digital ping voltage reported by the additional electronic device.

6. The electronic device of claim 1, further comprising:
a charging surface; and
one or more sensors configured to determine a location of an additional wireless power transfer coil in the additional electronic device on the charging surface.

7. The electronic device of claim 6, wherein moving the wireless power transfer coil using the positioning equipment during the second pause comprises:
using the one or more sensors to determine a first location of the additional wireless power transfer coil on the charging surface; and
moving the wireless power transfer coil to be aligned with the first location of the additional wireless power transfer coil.

8. The electronic device of claim 7, wherein the control circuitry is configured to, before commencing the wireless power transfer operation:
use the one or more sensors to determine a second location of the additional wireless power transfer coil on the charging surface; and
move the wireless power transfer coil to be aligned with the second location of the additional wireless power transfer coil.

9. An electronic device configured to transfer wireless power with an additional electronic device, the electronic device comprising:
a wireless power transfer coil;
an inverter configured to supply alternating-current drive signals to the wireless power transfer coil;
positioning equipment configured to move the wireless power transfer coil; and
control circuitry configured to:
during a wireless power transfer session, identify that the additional electronic device has lowered a rectifier output load to a non-zero magnitude;
while the rectifier output load in the additional electronic device has the non-zero magnitude, determine an inductive coupling factor between the electronic device and the additional electronic device; and
based on the inductive coupling factor, move the wireless power transfer coil using the positioning equipment.

10. The electronic device of claim 9, wherein moving the wireless power transfer coil based on the inductive coupling factor comprises moving the wireless power transfer coil based on the inductive coupling factor in accordance with determining that the inductive coupling factor is lower than a threshold inductive coupling factor.

11. The electronic device of claim 9, wherein the non-zero magnitude of the rectifier output load is less than a target rectifier output load associated with real time operating characteristics of the additional electronic device.

12. The electronic device of claim 9, wherein identifying that the additional electronic device has lowered the rectifier output load to the non-zero magnitude comprises transmitting an instruction to the additional electronic device to cause the additional electronic device to lower the rectifier output load to the non-zero magnitude.

13. The electronic device of claim 9, wherein identifying that the additional electronic device has lowered the rectifier output load to the non-zero magnitude comprises receiving information from the additional electronic device indicating that the additional electronic device is lowering the rectifier output load to the non-zero magnitude.

14. The electronic device of claim 9, further comprising:
a charging surface; and
one or more sensors configured to determine a location of an additional wireless power transfer coil in the additional electronic device on the charging surface.

15. The electronic device of claim 14, wherein moving the wireless power transfer coil using the positioning equipment based on the inductive coupling factor comprises:
using the one or more sensors to determine a first location of the additional wireless power transfer coil on the charging surface; and
moving the wireless power transfer coil to be aligned with the first location of the additional wireless power transfer coil.

16. The electronic device of claim 15, wherein the control circuitry is configured to, before commencing the wireless power transfer session:
use the one or more sensors to determine a second location of the additional wireless power transfer coil on the charging surface; and
move the wireless power transfer coil to be aligned with the second location of the additional wireless power transfer coil.

17. An electronic device configured to transfer wireless power with an additional electronic device, the electronic device comprising:
a wireless power transfer coil;
an inverter configured to supply alternating-current drive signals to the wireless power transfer coil;
positioning equipment configured to move the wireless power transfer coil; and
control circuitry configured to:
during a calibration phase of a wireless power transfer session, gather baseline efficiency information while transferring the wireless power with the additional electronic device;
during the wireless power transfer session, receive efficiency information from the additional electronic device while transferring the wireless power with the additional electronic device; and
based on the baseline efficiency information and the efficiency information from the additional electronic device, move the wireless power transfer coil using the positioning equipment.

18. The electronic device of claim 17, wherein gathering the baseline efficiency information during the calibration phase comprises determining efficiency magnitudes at multiple power levels of wireless power transfer between the electronic device and the additional electronic device.

19. The electronic device of claim 18, wherein gathering the baseline efficiency information during the calibration phase comprises determining efficiency magnitudes at multiple load conditions of wireless power transfer between the electronic device and the additional electronic device.

20. The electronic device of claim 17, wherein moving the wireless power transfer coil using the positioning equipment based on the baseline efficiency information and the efficiency information from the additional electronic device comprises:
using the baseline efficiency information, determining an efficiency threshold based on a current set of operating conditions;
comparing an efficiency magnitude indicated by the efficiency information from the additional electronic device to the efficiency threshold; and
moving the wireless power transfer coil using the positioning equipment in accordance with determining that the efficiency magnitude is less than the efficiency threshold.

21. The electronic device of claim 17, further comprising:
a charging surface; and
one or more sensors configured to determine a location of an additional wireless power transfer coil in the additional electronic device on the charging surface.

22. The electronic device of claim 21, wherein moving the wireless power transfer coil using the positioning equipment based on the baseline efficiency information and the efficiency information from the additional electronic device comprises:
using the one or more sensors to determine a first location of the additional wireless power transfer coil on the charging surface; and
moving the wireless power transfer coil to be aligned with the first location of the additional wireless power transfer coil.

23. The electronic device of claim 22, wherein the control circuitry is configured to, before commencing the wireless power transfer session:
use the one or more sensors to determine a second location of the additional wireless power transfer coil on the charging surface; and
move the wireless power transfer coil to be aligned with the second location of the additional wireless power transfer coil.
